(19) United States
(12) Patent Application Publication
(10) Pub. No.: US 2016/0017180 A1
(43) Pub. Date: Jan. 21, 2016

(54) FLUOROPOLYMER AND TITANIA BI-LAYER COATINGS

(71) Applicant: 3M INNOVATIVE PROPERTIES COMPANY, Saint Paul, MN (US)

(72) Inventors: Daniel J. Schmidt, Woodbury, MN (US); Timothy J. Hebrink, Scandia, MN (US)

(21) Appl. No.: 14/773,822

(22) PCT Filed: Mar. 12, 2014
(86) PCT No.: PCT/US2014/024495

§ 371 Date: Sep. 9, 2015

Related U.S. Application Data
(60) Provisional application No. 61/794,300, filed on Mar. 15, 2013.

(51) Int. Cl. C09D 181/08; C08K 3/22

(52) U.S. Cl. CPC C09D 181/08; C08K 3/22; C08K 2003/2241

(57) ABSTRACT

Articles including bi-layers of anionic and cationic self-limited monolayers are described. One monolayer comprises titanium dioxide and the other layer comprises a fluorinated polyelectrolyte. The use of titanium dioxide nanoparticles and perfluorinated polymers such as perfluorosulfonic acid polymer are described. Layer-by-layer, self-assembled layers and processes of producing such layers are also described.

### FIELD

The present disclosure relates to bi-layer coatings. The bi-layers include a first self-assembled monolayer containing titanium dioxide, and a second self-assembled monolayer containing a fluorinated polymer. Articles incorporating a plurality of such bi-layers and methods of making such articles are also described.

### SUMMARY

Briefly, in one aspect, the present disclosure provides an article comprising a substrate and a coating bonded to a surface of the substrate. The coating comprises m bi-layers, wherein each bi-layer comprises a first self-limited monolayer and an adjacent second self-limited monolayer, wherein one of the monolayers comprises titanium dioxide and the other monolayer comprises a fluorinated polyelectrolyte. The number of bi-layers, m, is an integer greater than or equal to 1. In some embodiments, m is greater than or equal to 5. In some embodiments, m is no greater than 20.

In some embodiments, the titanium dioxide comprises titanium dioxide nanoparticles. In some embodiments, the average diameter of the nanoparticles is no greater than 750 nanometers, e.g., between 5 and 25 nanometers, inclusive. In some embodiments, the monolayer comprising titanium dioxide is substantially free of a polymeric component.

In some embodiments, the fluorinated polyelectrolyte is perfluorinated, e.g., a perfluorosulfonic acid polymer.

In some embodiments, one of the monolayers is bonded directly to the surface of the substrate. In some embodiments, a first layer is bonded to the surface of the substrate, and one of the monolayers is bonded directly to the first layer. In some embodiments, the first layer is a third self-limited monolayer.

In some embodiments, the article further comprises a second layer disposed on the surface of the bi-layer farthest from the substrate. In some embodiments, the second layer is a fourth self-limited monolayer.

In some embodiments, the surface of the substrate is negatively charged. In some embodiments, the surface of the substrate is positively charged. In some embodiments, the substrate comprises glass. In some embodiments, the substrate comprises a polymeric film.

In some embodiments, each monolayer is a Layer-by-Layer self-assembled monolayer.

The above summary of the present disclosure is not intended to describe each embodiment of the present invention. The details of one or more embodiments of the invention are also set forth in the description below. Other features, objects, and advantages of the invention will be apparent from the description and from the claims.

### BRIEF DESCRIPTION OF THE DRAWINGS

FIG. 1 illustrates an article according to some embodiments of the present disclosure.

FIG. 2 illustrates another article according to some embodiments of the present disclosure.

### DETAILED DESCRIPTION

Layer-by-layer (LBL) self-assembly is a coating technique that allows precise control of nanoscale coating thicknesses. LBL technology can be used to make a wide variety of optical coatings, biomedical coatings, as well as gas barrier and flame retardant coatings, among other applications. Generally, environmentally-friendly aqueous coating solutions may be used, and conformal coating of non-planar substrates is possible. Coatings can be prepared from a wide material set including both polymers and nanoparticles.

The coating process is based upon the alternating adsorption of materials with complementary functional groups. For example, when a negatively-charged substrate (e.g., glass) is dipped into a solution containing a polycation (e.g. polydiallydimethylammonium chloride), the polycation will diffuse to and adsorb onto the surface until the surface charge is reversed resulting in a self-limited monolayer. That is, the diffusion and absorption will continue until there are substantially no accessible anionic sites on the substrate. As understood by one of ordinary skill in the art, the self-limited layer formed may not be a true monolayer. For example, steric hindrance and process variability may result in minor variations from a true monolayer. In addition, nanoparticles may deposit in the form of aggregates, such that the monolayer may comprise both single nanoparticles and aggregates of nanoparticles. Also, in some embodiments, polymeric material may diffuse into the absorbed polymer layer that is not readily removed in the rinsing step. However, as used herein, the term self-limited monolayer encompasses such known variations.

Following the formation of the first self-limited monolayer, this substrate may be rinsed to remove excess, weakly-bound material. The resulting positively-charged (i.e., polycation-modified) substrate can then be immersed in a solution containing a polyanion (e.g. polyacrylic acid). Again, the polymer will diffuse to and adsorb onto the surface until the surface charge is reversed forming a second self-limited monolayer. A rinse step then removes excess material.

This cycle can be repeated to build up a coating, layer-by-layer, with each layer being a self-limited monolayer. Obviously, the same process could be performed starting with a positively charged substrate, reversing the order in which the anionic and cationic layers are applied. Previously, this was only a slow, tedious coating method used in academia. Now, however, layer-by-layer assembly has been demonstrated on an industrial scale via roll-to-roll spray coating processes by, e.g., Svaya Nanotechnologies, Inc. (Sunnyvale, Calif.).

Coatings are generally denoted as (Polycation/Polyanion)ₘ where m is the number of deposited “bi-layers.” A bi-layer refers to the combination of a polycation layer and a polyanion layer. Generally, any number of bi-layers, m, may be present. In some embodiments, m is at least 5, e.g. at least 10. In some embodiments, m is no greater than 50, e.g., no greater than 20. In some embodiments, m is between 5 and 20, inclusive, e.g., between 10 and 20, inclusive.

Generally, a polycation layer can comprise cationic polymers or cationic nanoparticles. Likewise, a polyanionic layer can comprise anionic polymers or anionic nanoparticles. Layers incorporating nanoparticles may also incorporate a polymeric binder. However, in some embodiments, the layer comprising nanoparticles is substantially free (e.g., free) of polymeric binders.

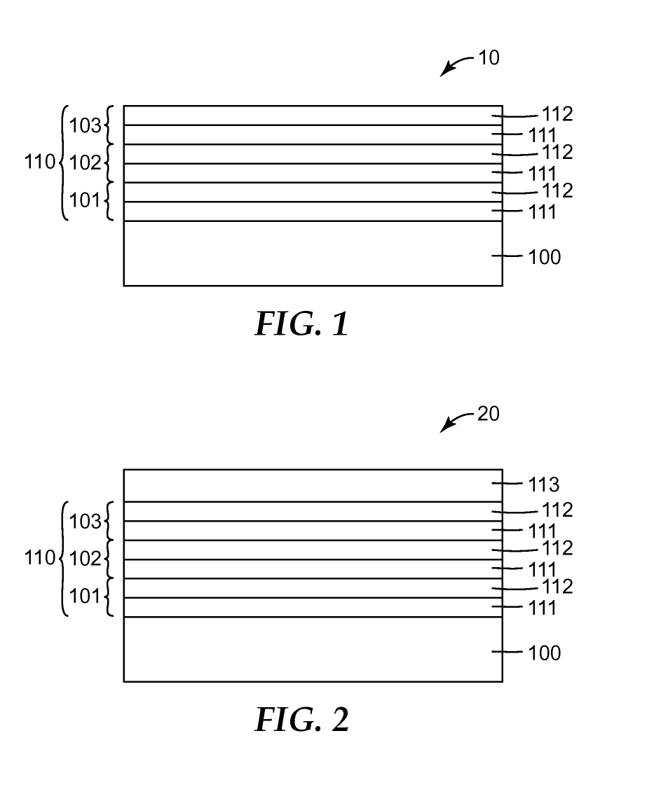

An exemplary article comprising a layer-by-layer assembled coating is illustrated in FIG. 1. Article 10 includes substrate 100 and coating 110. Coating 110 includes three bi-layers, 101, 102, and 103. Generally, the number of bi-layers may be selected based on the materials used and the desired end-use of the article. Each bi-layer comprises a cationic layer and an anionic layer. In the embodiment of FIG. 1, cationic layer 111 is shown adjacent to substrate 100 with anionic layer 112 deposited on cationic layer 111. Depending on the choice of substrate, in some embodiments, the anionic layer may be adjacent the substrate.

In addition, in some embodiments, one or more additional layers may be present. For example, in some embodiments, one or more layers, e.g., a primer layer, may be located between the substrate and the first bi-layer. Referring to article 20 of FIG. 2, in some embodiments, one or more layers 113, may be located on the surface of the last bi-layer. In some embodiments, the additional layer 113 may comprise one of the bi-layer materials, i.e., layer 113 may be substantially the same as, or even the same composition as layer 111. In some embodiments, the additional layers may be applied in a layer-by-layer process. In some embodiments, other known methods may be used to apply such layers.

Frequently, hydrocarbon polyelectrolytes (polyanions and polycations) have been used in layer-by-layer coatings. Exemplary hydrocarbon polyelectrolytes include poly(diallyldimethyl ammonium chloride), polyethyleneimine, polyallylamine, poly(sodium 4-styrenesulfonate), and poly(vinyl phosphoric acid). Many other hydrocarbon polyelectrolytes are known and may be suitable for use in some embodiments of the present disclosure.

Nanoparticles have also been used as components of layer-by-layer coatings. Generally, nanoparticles are particles having a maximum cross-sectional dimension of less than one micron. In some embodiments, the average cross-sectional dimension is no greater than 750 nanometers (nm), e.g., no greater than 150 nm, no greater than 50 nm, or even no greater than 20 nm. In some embodiments, the average cross-sectional dimension is at least 5 nm, e.g., at least 10 nm. In some embodiments, the average cross-sectional dimension is between 5 and 50 nm, inclusive; e.g., between 5 and 25 nm, inclusive; or even 5 to 15 nm, inclusive.

Layers containing titanium dioxide, also referred to as titania, have been used to selectively reflect or transmit certain wavelengths of light. Titania layers are widely used in multilayer optical coatings, such as in ultra-violet (UV) reflectors, infra-red (IR) reflectors, broadband mirrors, and anti-reflection coatings. Titania is often selected for its high refractive index, which can reduce the number of optical stacks required for a certain level of reflection or transmission and can widen the bandwidth of reflection or transmission relative to lower index materials.

Titania layers can be made by layer-by-layer self assembly, as well as other methods such as sputtering, thermal/e-beam evaporation, chemical vapor deposition, atomic layer deposition, and sol-gel coating. In a layer-by-layer process, a suspension containing titanium dioxide nanoparticles can serve as the source of cationic or anionic material. For example, in solutions or suspensions having a pH lower that its isoelectric point, titania can be a source of cationic material. While in solutions or suspensions having a pH greater that its isoelectric point, titania can be a source of anionic material. Alternatively, titania may be surface-modified to provide a cationic or anionic material. A multi-layer coating is then obtained by exposing a substrate to alternating solutions containing the titania suspension, and e.g., a polyanionic or polycationic polymer and.

Titania is available in a variety of crystalline forms such as rutile, which is not known to be photocatalytic. However, the anatase crystalline form, commonly found in nanoscale titania, is photocatalytic in that it catalyzes the breakdown of water to oxygen and hydroxyl radicals. These reactive radical species can rapidly degrade organic materials. Although photocatalysis can be a useful property in the development of self-cleaning coatings and roofing shingles, for example, it can be a detriment when desired materials (e.g. polymer binders in the coating and/or the coating substrate) are degraded. Such degradation can lead to loss of coating adhesion to the substrate, as well as breakdown of optical and mechanical properties.

Surprisingly, the present inventors have discovered that photocatalytic degradation of polymers used in titania-containing layer-by-layer coatings can be diminished by using a fluorinated polyelectrolyte rather than a hydrocarbon polyelectrolyte. As used herein, a fluorinated polyelectrolyte (also referred to as a fluoropolymer electrolyte) includes both partially fluorinated and perfluorinated polyelectrolytes. Also, as used herein, a fluorinated polyelectrolyte is considered distinct and different from a hydrocarbon polyelectrolyte. Thus, the term hydrocarbon polyelectrolyte excludes fluorinated polyelectrolytes, regardless of their level of fluorination.

While not particularly limited, suitable fluoropolymer electrolytes include those available under the trade name NAFION from DuPont Fluoroproducts, Fayetteville, N.C., such as NAFION PFSA Super Acid Resins NR-40 and NR-50 perfluorosulfonic acid polymer. Such materials are said to comprise a copolymer of tetrafluoroethylene and perfluoro-3,6-dioxa-4-methyl-7-octenesulfonyl fluoride, converted to the proton form, with the following chemical structure:

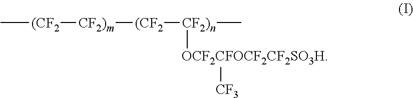

In some embodiments, fluoropolymer ionomers, such as those available from 3M Company, St. Paul, Minn., may also be used. For example, perfluorinated sulfonic acid (PFSA) polymer having the following structure may be used.

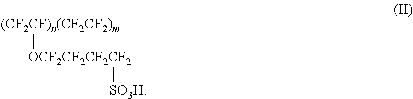

As illustrated in the following examples, fluoropolymer polyelectrolytes produced increased UV and oxidative stability compared to hydrocarbon polyelectrolytes and thus are less susceptible to photocatalytic degradation. In some embodiments, perfluorinated polyelectrolytes may be preferred.

### EXAMPLES

TABLE 1
Summary of materials used in the preparation of the examples.

| Name | Description | Trade Name and Source |
|---|---|---|
| Titania | anatase titania nanoparticles (5-15 nm diameter) | U.S. Research Nanomaterials, |
| | (obtained as a 15 wt. % suspension in water) | Houston, Texas |
| PSS | poly(sodium 4-styrenesulfonate) | Sigma Aldrich, |
| | (negatively charged polymer (i.e., polyanionic)), | St. Louis, Missouri |
| | obtained from as a 30 wt. % solution in water with | |
| | polymer molecular weight of 70K | |
| PVPA | polyvinyl phosphoric acid) | Rhodia Consumer Specialties, |
| | (negatively charged polymer (i.e. polyanionic) | Oldbury, UK under the |
| | | tradename ALBRITECT |
| PF-SAP | perfluorinated sulfonic acid polymer, | Sigma Aldrich, |
| | (negatively charged perfluoropolymer)), | NAFION |
| | obtained as a 10 wt. % dispersion in water | |
| HNO3 | nitric acid | VWR |
| | | West Chester, Pennsylvania |
| IPA | isopropyl alcohol | VWR |

The pH Method. The pH of the solutions used for coating was determined using a VWR sympHony® rugged bulb pH electrode connected to a VWR sympHony® pH meter. Standard buffer solutions were used for calibration.

The Thickness and Refractive Index Method. Coating thickness was determined with spectroscopic ellipsometry using a J. A. Woollam M-2000 variable angle ellipsometer from 370-1500 nanometers (nm) at angles of 50, 60, and 70 degrees. First, data were acquired on the bare substrate (a glass microscope slide) with the backside masked with matte finish tape (available under the trade name SCOTCH from 3M Company, St. Paul, Minn.) to eliminate backside reflection. Next, data were acquired for the coated substrates with the backside masked with the tape. Before application of the tape, the coatings were removed from the backside of the substrate with a razor blade.

The optical model developed to fit the ellipsometry data comprised two separate layers. Specifically, the substrates and the coatings were modeled as separate single material layers with two-parameter Cauchy functions:

n=A+B/λ²

where n is the refractive index, λ (lambda) is wavelength in units of micrometers, and A and B are constants. The optical constants for the substrate were determined from ellipsometric data on the bare substrate and were then held constant when fitting data from the coated samples. Coating thickness and constants A and B were iteratively varied with WVASE 32 software until the error between the model and experimental data was minimized. In some cases, a surface roughness layer was added to the optical model to improve the fit to the data. The roughness layer consists of 50% of the underlying Cauchy material and 50% air (n=1.00). Thickness was measured at three or four separate locations on each sample.

### The UV Stability Method

Coatings were exposed to ultraviolet radiation (365 nm) in a RAYONET UV Photoreactor (Model RPR-100) available from Southern New England Ultraviolet Company (Branford, Conn.). The coatings on glass slides were suspended in the center of the photoreactor with an alligator clip. The fan was turned on, resulting in an operating temperature of about 35° C. according to the manufacturer. The thickness and refractive index of each coating were measured before UV exposure and after eight hours of UV exposure. Photocatalytic degradation was deemed to have been suppressed when the thickness of the coating changed by no greater than 5% and when the refractive index at 633 nm changed by no greater than 0.05.

The LBL Coating Method. Layer-by-layer coatings were made using a StratoSequence VI (nanoStrata Inc., Tallahassee, Fla.) dip coating robot. Glass microscope slides (8.9 cm×2.5 cm×1 mm) were rinsed with IPA and deionized (DI) water and then mounted in the sample holder of the StratoSequence VI robot. The substrate was first immersed in the solution of titania nanoparticles for one minute. Next, the substrate was immersed in three separate water rinse baths for thirty seconds each. Next, the substrate was immersed in a solution of polyanionic polymer for one minute. Next, the substrate was immersed in three separate water rinse baths for thirty seconds each. During each immersion step, the substrate was rotated in the solution at about ninety revolutions per minute. This sequence of alternating immersion cycles was used to deposit one bi-layer, and was repeated the desired number of times to make coatings with the desired thickness. The coatings are generally denoted as (Polycation/Polyanion)ₘ where m is the number of deposited bi-layers.

### Comparative Example 1 (CE-1)

A 0.1 wt. % solution of PSS was prepared by diluting the 30 wt. % aqueous solution in DI water and adjusting the pH to 2.0 with HNO3. A 0.1 wt % suspension of titania nanoparticles was prepared by diluting the 15 wt. % suspension in DI water and adjusting the pH to 2.0 with HNO3. NaCl was added to the tiantia suspension to a final concentration of 0.1 M. The rinse water was adjusted to pH 2.0 with HNO3. A (TiO2/PSS)₁₀ (i.e., m=10, indicating ten bi-layers) coating was prepared using the LBL Coating Method.

### Comparative Example 2 (CE-2)

A 0.1 wt % solution of PVPA was prepared by diluting the ALBRITECT solution in DI water and adjusting the pH to 2.0 with HNO3. A (TiO2/PVPA)₁₀ (i.e., ten bi-layers) coating was prepared using the LBL Coating Method, using the titania solution and rinse water described in CE-1.

### Example 1 (EX1)

A 0.1 w% solution of PF-SAP was prepared by diluting the NAFION solution with DI water and adjusting the pH to 2.0 with HNO3. A (TiO2/PF-SAP)₁₀ (i.e., ten bi-layers) coating was prepared using the LBL Coating Method, using the titania solution and rinse water described in CE-1.

The coating thickness and refractive index of the samples were evaluated according to the Thickness and Refractive Index Method. Measurements were taken before and after subjecting the samples to ultraviolet light in accordance with the UV Stability Method. The results are reported in Table 2.

TABLE 2
Summary of results.

| | Thickness (nm) | | | Refractive Index at 633 nm | | |
|---|---|---|---|---|---|---|
| I.D. | Initial | after UV | Change | Initial | after UV | Change |
| CE-1 | 126 ± 3 | 114 ± 3 | −10% | 1.87 | 1.81 | −0.06 |
| CE-2 | 123 ± 3 | 107 ± 0 | −13% | 1.63 | 1.63 | 0 |
| EX-1 | 97 ± 1 | 92 ± 2 | −5% | 1.78 | 1.78 | 0 |

Modifications and alterations of this invention will become apparent to those skilled in the art without departing from the scope and spirit of this invention.

1. An article comprising a substrate and a coating bonded to a surface of the substrate, wherein the coating comprises m bi-layers, wherein each bi-layer comprises a first self-limited monolayer and an adjacent second self-limited monolayer, wherein one of the monolayers comprises titanium dioxide and the other monolayer comprises a fluorinated polyelectrolyte; wherein m is an integer greater than or equal to 1.

2. The article of claim 1, wherein m is greater than or equal to 5.

3. The article of claim 1, wherein m is no greater than 20.

4. The article according to claim 1, wherein the titanium dioxide comprises titanium dioxide nanoparticles having an average diameter of no greater than 750 nanometers.

5. The article of claim 4, wherein the titanium dioxide nanoparticles have an average diameter of between 5 and 25 nanometers, inclusive.

6. The article according to claim 1, wherein the monolayer comprising titanium dioxide is substantially free of a polymeric component.

7. The article according to claim 1, wherein the fluorinated polyelectrolyte is perfluorinated.

8. The article of claim 7, wherein the fluorinated polyelectrolyte is a perfluorosulfonic acid polymer.

9. The article according to claim 1, wherein one of the monolayers is bonded directly to the surface of the substrate.

10. The article according to claim 1, further comprising a first layer bonded to the surface of the substrate, wherein one of the monolayers is bonded directly to the first layer.

11. The article of claim 10, wherein the first layer is a third self-limited monolayer.

12. The article according to claim 1, further comprising a second layer disposed on the surface of the bi-layer farthest from the substrate.

13. The article of claim 12, wherein the second layer is a fourth self-limited monolayer.

14. The article according to claim 1, wherein the surface of the substrate is negatively charged.

15. The article according to claim 1, wherein the surface of the substrate is positively charged.

16. The article according to claim 1, wherein the substrate comprises glass.

17. The article according to claim 1, wherein the substrate comprises a polymeric film.

18. The article according to claim 1, wherein each monolayer is a Layer-by-Layer self-assembled monolayer.
